(19) United States
(12) Patent Application Publication
(10) Pub. No.: US 2008/0129693 A1
(43) Pub. Date: Jun. 5, 2008

(54) Shape-adjustable computer input device

(76) Inventors: Zhen-Bang Chen, Taipei County (TW); Jia-Min Huang, Taipei County (TW); Shou-Min Hong, Taipei County (TW)

Correspondence Address: Raymond Sun, Suite 155, 20 Corporate Park, Irvine, CA, 92606, US

(21) Appl. No.: 11/656,144

(22) Filed: Jan. 22, 2007

(30) Foreign Application Priority Data
Dec. 4, 2006 (TW) 095144975

(51) Int. Cl. G06F 3/033

(52) U.S. Cl. 345/157

(57) ABSTRACT

An input device has a main body having a peripheral edge, and a swinging portion pivotally connected to the main body along a rear portion of the peripheral edge, with the swinging portion pivoting between at least two different positions along the rear portion of peripheral edge. The swinging portion can also be extended and retracted with respect to the main body along the longitudinal axis of the main body.

### BACKGROUND OF THE INVENTION

1. Field of the Invention

The present invention relates to an input device, and in particular, to a computer input device whose shape can be adjusted.

2. Description of the Prior Art

Conventional computer input devices, such as computer mice, are usually designed to have straight holding portions so that both right-handed and left-handed users can feel comfortable using them. Other conventional input devices are, however, designed for the comfort of right-handed users, since a majority of the population is right-handed.

### SUMMARY OF THE DISCLOSURE

It is an object of the present invention to provide a shape-adjustable input device which allows for comfortable use by both right-handed and left-handed users.

It is another object of the present invention to provide a shape-adjustable input device which allows for comfortable use by users with large hands and users with small hands.

In order to accomplish the objects of the present invention, the present invention provides an input device having a main body having a peripheral edge, and a swinging portion pivotally connected to the main body along a rear portion of the peripheral edge, with the swinging portion pivoting between at least two different positions along the rear portion of peripheral edge. The swinging portion can also be extended and retracted with respect to the main body along the longitudinal axis of the main body.

### BRIEF DESCRIPTION OF THE DRAWINGS

FIG. 1 is a perspective view of an input device according to the present invention.

FIG. 2 is an exploded perspective view of the input device of FIG. 1.

FIGS. 3A-3C are cross-sectional views illustrating the extension of the swinging portion of the input device of FIG. 1.

FIGS. 4A-4B are top plan views illustrating the pivoting of the swinging portion of the input device of FIG. 1.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

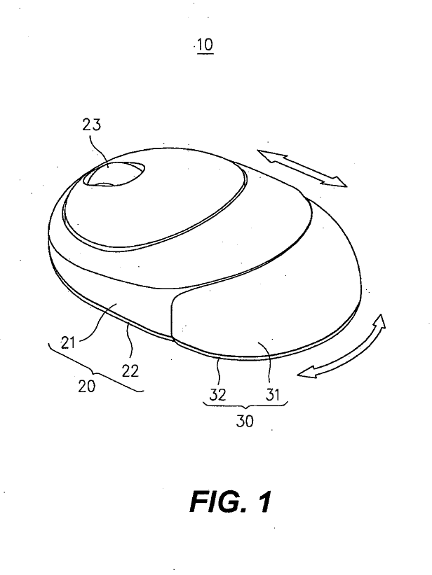

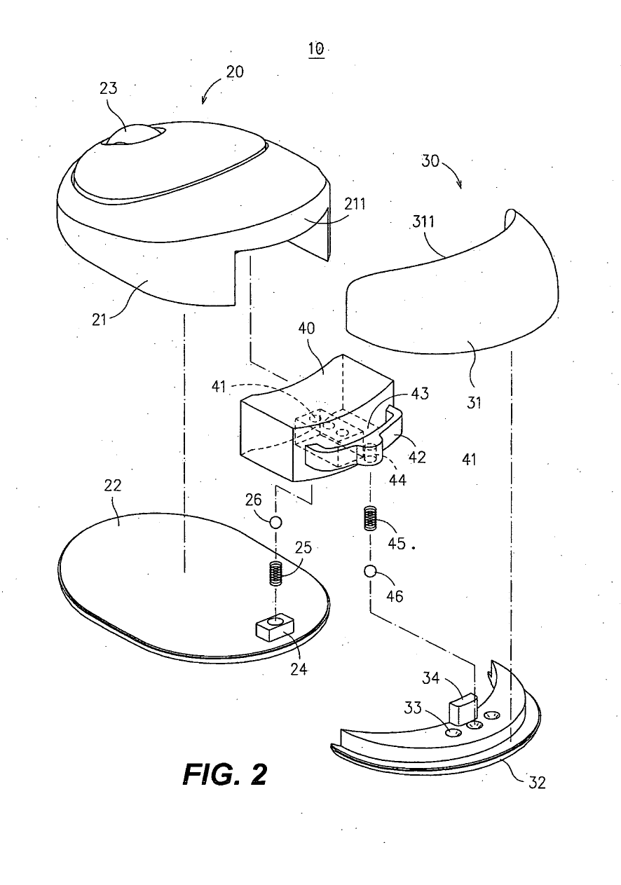

Referring to FIGS. 1 and 2, the input device 10 of the present invention can be a computer input device such as a mouse, trackball, game controller or the like. The input device 10 has a main body 20 and a swinging portion 30. The swinging portion 30 is coupled to one end (e.g., the rear end) of the main body 20. The main body 20 has an upper housing 21 and a lower housing 22 that are secured together, and the swinging portion 30 also has an upper housing 31 and a lower housing 32 that are secured together. A roller 23 is located on the top of the upper housing 21. The rear end of the main body 20 has a peripheral convex surface 211 while the swinging portion 31 has a peripheral concave surface 311 that is aligned with the convex surface 211.

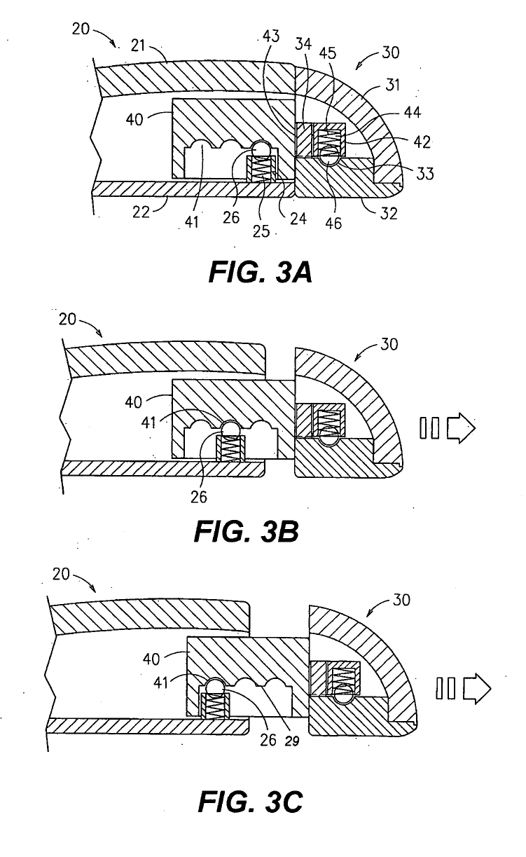

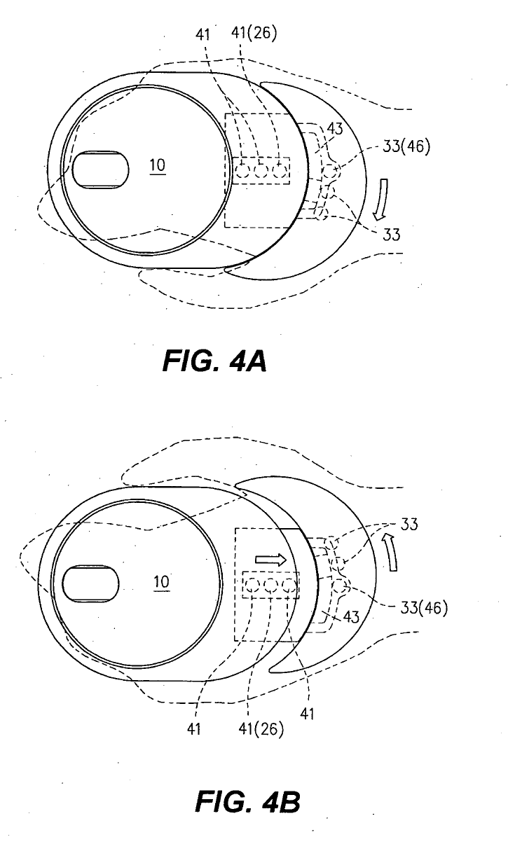

A connector 40 is secured to the lower housing 22, and is positioned between the main body 20 and the swinging portion 30. The connector 40 connects the main body 20 to the swinging portion 30 in a manner which allows the swinging portion 30 to be pivoted, and reciprocated in a straight line (i.e., retracted and extended), with respect to the main body 20. A handle-like fringe 42 extends from the rear of the connector 40 in a manner such that a slot 43 is formed between the connector 40 and the fringe 43. The swinging portion 30 has a bulge 34 extending upwardly from the lower housing 32, and the bulge 34 is positioned within the slot 43 as best shown in FIGS. 3A and 4A. The slot 43 is curved such that the bulge 34 can move along the slot 43 along an arcuate path as illustrated in FIGS. 4A and 4B.

A first positioning mechanism is located between the connector 40 and the swinging portion 30. The first positioning mechanism includes a plurality of hemispherical cavities 33 spaced apart on the lower housing 32, a ball 46, a spring 45 and a bore 44 provided at about the center of the fringe 42. Referring to FIG. 3A, the ball 46 and the spring 45 are firmly secured within the bore 44 in a manner such that the ball 46 will always be retained within one of the cavities 33. In particular, the spring 45 normally biases the ball 46 out of the bore 44, but this normal bias can be overcome when the swinging portion 30 is pivoted to the left or the right, with the upper surface of the lower housing 32 (i.e., between adjacent cavities 33) pressing the ball 46 upwardly as the lower housing 32 (and the cavities 33) are pivoted to the left or the right. As shown in FIGS. 4A and 4B, as the swinging portion 33 is pivoted to the left or the right, the bulge 34 moves within the slot 43 while the connector 40 is positioned at the same location (i.e., connector 40 does not pivot) as the ball 46 moves from one cavity 33 into an adjacent cavity 33. This allows the user to adjust the angle of the swinging portion 30 with respect to the main body 20. In particular, the swinging portion 30 can be pivoted to the left for use by a right-handed user (see FIG. 4A), and pivoted to the right for use by a left-handed user (see FIG. 4B).

A second positioning mechanism is located between the lower housing 22 of the main body 20 and the connector 40. The second positioning mechanism includes a plurality of cavities 41 spaced apart on a straight line along the bottom of the connector 40, a ball 26, a spring 25 and a bore 24, which can be the same as the cavities 33, ball 46, spring 45 and bore 44, respectively. Referring to FIG. 3A, the ball 26 and the spring 25 are firmly secured within the bore 24 in a manner such that the ball 26 will always be retained within one of the cavities 41. In particular, the spring 25 normally biases the ball 26 upwardly out of the bore 24, but this normal bias can be overcome when the swinging portion 30 is extended or retracted along the longitudinal axis of the main body 20 (i.e., when the connector 40 is extended or retracted from the main body 20), with the lower inner surface 29 of the connector 40 (see FIG. 3C) (i.e., between adjacent cavities 41) pressing the ball 26 upwardly as the connector 40 (and the cavities 41) is extended or retracted. As shown in FIGS. 3A and 3B, as the swinging portion 30 is pulled out or pushed in, the ball 26 moves from one cavity 41 into an adjacent cavity 41 to allow the user to position the swinging portion 20 at a desired distance away from the main body 20. This lateral extension-retraction allows the overall size of the input device 10 to be adjusted to accommodate the size of the user's hand.

Both of the main body 20 and the swinging portion 30 are placed on a working surface such that a user can operate it as a computer mouse or a trackball as shown in FIGS. 3A and 4A. In addition, the swinging portion 30 can be sized and configured to support the base of a user's palm according to the natural shape of a right or left hand, as shown in FIGS. 4A and 4B.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A shape-adjustable computer input device, comprising:
a main body having a peripheral edge; and
a swinging portion pivotally connected to the main body along a rear portion of the peripheral edge, with the swinging portion pivoting between at least two different positions along the rear portion of peripheral edge.

2. The input device of claim 1, wherein the rear portion of the peripheral edge has an arcuate surface, and the swinging portion has a corresponding arcuate surface that is aligned with the arcuate surface of the rear portion.

3. The input device of claim 1, further including a connector which couples the main body to the swinging portion.

4. The input device of claim 3, wherein the connector has a slot and the swinging portion has a bulge, with the bulge positioned inside the slot for motion within the slot.

5. The input device of claim 3, wherein a first positioning mechanism is located between the connector and the swinging portion.

6. The input device of claim 5, wherein the first positioning mechanism includes a resilient element, a ball and a plurality of cavities, with the resilient element biasing the ball to be seated in one of the plurality of cavities as the swinging portion is pivoted.

7. The input device of claim 3, wherein the swinging portion is extendable and retractable with respect to the main body.

8. The input device of claim 5, wherein a second positioning mechanism is located between the connector and the main body.

9. The input device of claim 8, wherein the second positioning mechanism includes a resilient element, a ball and a plurality of cavities, with the resilient element biasing the ball to be seated in one of the plurality of cavities as the swinging portion is extended or retracted with respect to the main body.

10. A shape-adjustable computer input device, comprising:
a main body having a peripheral edge;
a swinging portion; and
a connector located between the main body and the swinging portion, wherein connector has a first end that is coupled to the main body and a second end that is pivotally coupled to the swinging portion such that the swinging portion pivots along a portion of the peripheral edge.

11. The input device as claimed in claim 10, wherein the connector has a slot and the swinging portion has a bulge, with the bulge positioned in, and movable within, the slot.

12. The input device of claim 10, wherein a positioning mechanism is located between the connector and the swinging portion.

13. The input device of claim 12, wherein the positioning mechanism includes a resilient element, a ball and a plurality of cavities, with the resilient element biasing the ball to be seated in one of the plurality of cavities as the swinging portion is pivoted.

14. The input device of claim 10, wherein the connector is extendable and retractable with respect to the main body.

15. The input device of claim 10, wherein a positioning mechanism is located between the connector and the main body.

16. The input device of claim 15, wherein the positioning mechanism includes a resilient element, a ball and a plurality of cavities, with the resilient element biasing the ball to be seated in one of the plurality of cavities as the swinging portion is extended or retracted with respect to the main body.

17. A shape-adjustable computer input device, comprising:
a main body having a longitudinal axis and a peripheral edge; and
a swinging portion coupled to the main body along a rear portion of the peripheral edge in a manner which allows the swinging portion to (i) pivot between at least two different positions along the rear portion of peripheral edge, and (ii) extend and retract with respect to the main body along the longitudinal axis.
